(19) United States
(12) Patent Application Publication
(10) Pub. No.: US 2019/0197894 A1
(43) Pub. Date: Jun. 27, 2019

(54) SYSTEMS AND METHODS FOR INFORMATION PROCESSING

(71) Applicant: BEIJING DIDI INFINITY TECHNOLOGY AND DEVELOPMENT CO., LTD., Beijing (CN)

(72) Inventors: Hongjing SUN, Beijing (CN); Yuchu CAO, Beijing (CN); Yang MENG, Beijing (CN)

(73) Assignee: BEIJING DIDI INFINITY TECHNOLOGY AND DEVELOPMENT CO., LTD., Beijing (CN)

(21) Appl. No.: 16/236,598

(22) Filed: Dec. 30, 2018

Related U.S. Application Data
(63) Continuation of application No. PCT/CN2018/089139, filed on May 31, 2018.

(30) Foreign Application Priority Data
Jun. 8, 2017 (CN) 201710428140.2

(51) Int. Cl. G08G 1/0968; G08G 1/00; H04W 4/40; H04W 4/029

(52) U.S. Cl. CPC G08G 1/096838; G08G 1/202; H04W 4/029; H04W 4/40; G08G 1/205

(57) ABSTRACT

A method for creating a user group is provided. The method may include obtaining order information from a plurality of users. The method may include classifying the plurality of users into one or more user groups based on the order information. The method may also include sending invitation information for joining a user group to each of the plurality of users of the one or more user groups. The method may further include receiving response information associated with the invitation information from at least a part of the plurality of users, and adding the at least a part of the plurality of users into the user groups based on the response information.

### CROSS-REFERENCE TO RELATED APPLICATIONS

This application is a continuation of International Application No. PCT/CN2018/089139, filed on May 31, 2018, which further claims priority of Chinese Patent Application No. 201710428140.2 filed on Jun. 8, 2017. The entire contents of these applications are incorporated herein by reference.

### TECHNICAL FIELD

The present disclosure generally relates to computer based information processing, and more particularly, relates to systems and methods for target grouping and/or classification.

### BACKGROUND

Online car-hailing services (e.g., car-pooling services) have become more and more popular. Any driver having a private car may access an online car-hailing service after the driver registers as a member, which brings about potential security risks (e.g., crimes) for a passenger to a certain extent. Therefore, it is necessary to develop a system or a method to ensure the safety of the passenger during his/her journey.

### SUMMARY

According to an aspect of the present disclosure, a method for creating one or more user groups is provided. The method may include one or more of the following operations. A processor may obtain order information from a plurality of users. The processor may classify the plurality of users into one or more user groups based on the order information. The processor may send invitation information for joining a user group to each of the plurality of users of the one or more user groups. When receiving response information associated with the invitation information from at least a part of the plurality of users, the processor may add the at least a part of the plurality of users into the one or more user groups based on the response information.

In some embodiments, the processor may obtain destinations of the plurality of users, and classify the plurality of users into the one or more user groups based on the destinations of the plurality of users.

In some embodiments, the processor may determine a distance between destinations of any two of the plurality of users. The processor may determine the one or more user groups by comparing the distance with a threshold. The processor may further classify the plurality of users into the one or more user groups based on the comparison.

In some embodiments, the processor may obtain current locations and corresponding destinations of the plurality of users. The processor may determine a traveling time for each of the plurality of users based on the current locations and corresponding destinations, and classify the plurality of users into the one or more user groups based on the traveling time for each of the plurality of users.

In some embodiments, the processor may determine traveling time differences between any two of the plurality of users. The processor may determine absolute values of the traveling time differences. The processor may determine one or more user groups by comparing the absolute values with a threshold, and classify the plurality of users into the one or more user groups based on the comparison.

In some embodiments, the response information may include confirmation information and user preferences.

In some embodiments, the processor may classify the plurality of users into one or more primary user groups based on the order information.

In some embodiments, the processor may determine a plurality of categories of the user preferences based on the response information, the primary group including the at least a part of the plurality of users that are sent to the confirmation information. The processor may create a plurality of secondary user groups corresponding to the plurality of categories of the user preferences, and add the at least a part of the plurality of users of the primary group into the plurality of secondary user groups.

In some embodiments, the user preferences may include gender information and a number of users in a user group.

In some embodiments, the processor may determine a first plurality of categories of the gender information based on the response information. The processor may determine a second plurality of categories of the number of users based on the response information, and determine the plurality of categories of the user preferences based on the first plurality of categories of the gender information and the second plurality of categories of the number of users.

In some embodiments, the processor may further receive from a user of the one or more users exit information for seceding from the one or more user groups, and remove the user out of the one or more groups accordingly.

According to another aspect of the present disclosure, a system is provided. The system may include at least one storage medium and at least one processor configured to communicate with the at least one storage medium. The at least one storage medium may include a set of instructions. When the at least one storage medium executes the set of instructions, the at least one processor may be directed to perform one or more of the following operations. The at least one processor may obtain order information from a plurality of users. The at least one processor may classify the plurality of users into one or more user groups based on the order information. The at least one processor may send invitation information for joining a user group to each of the plurality of users of the one or more user groups. The at least one processor may receive response information associated with the invitation information from at least a part of the plurality of users. The at least one processor may add the at least a part of the plurality of users into user groups based on the response information.

According to another aspect of the present disclosure, a non-transitory computer readable medium is provided. The non-transitory computer readable medium may comprise executable instructions that cause at least one processor to effectuate a method. The method may include one or more of the following operations. The at least one processor may obtain order information from a plurality of users. The at least one processor may classify the plurality of users into one or more user groups based on the order information. The at least one processor may send invitation information for joining a user group to each of the plurality of users of the one or more user groups. The at least one processor may receive response information associated with the invitation information from at least a part of the plurality of users. The at least one processor may add the at least a part of the plurality of users into user groups based on the response information.

### BRIEF DESCRIPTION OF THE DRAWINGS

The present disclosure is further described in terms of exemplary embodiments. These exemplary embodiments are described in detail with reference to the drawings. The drawings are not to scale. These embodiments are non-limiting exemplary embodiments, in which like reference numerals represent similar structures throughout the several views of the drawings, and wherein:

FIG. 1 is a schematic diagram illustrating an exemplary information processing system according to some embodiments of the present disclosure;

FIG. 2 is a schematic diagram illustrating an exemplary components of a computing device according to some embodiments of the present disclosure;

FIG. 3 is a schematic diagram illustrating hardware and/or software components of an exemplary mobile terminal according to some embodiments of the present disclosure;

FIG. 4 is a block diagram illustrating an exemplary processing engine according to some embodiments of the present disclosure;

FIG. 5 is a flowchart illustrating an exemplary process for creating user groups according to some embodiments of the present disclosure;

FIG. 6 is a flowchart illustrating an exemplary process for classifying a plurality of users into one or more user groups according to some embodiments of the present disclosure;

FIG. 7 is a flowchart illustrating an exemplary process for classifying a plurality of users into one or more user groups according to some embodiments of the present disclosure; and

FIG. 8 is a flowchart illustrating an exemplary process for creating user groups based on user preferences according to some embodiments of the present disclosure.

### DETAILED DESCRIPTION

In order to illustrate the technical solutions related to the embodiments of the present disclosure, brief introduction of the drawings referred to in the description of the embodiments is provided below. Obviously, drawings described below are only some examples or embodiments of the present disclosure. Those having ordinary skills in the art, without further creative efforts, may apply the present disclosure to other similar scenarios according to these drawings. Unless stated otherwise or obvious from the context, the same reference numeral in the drawings refers to the same structure and operation.

As used in the disclosure and the appended claims, the singular forms “a,” “an,” and “the” include plural referents unless the content clearly dictates otherwise. It will be further understood that the terms “comprises,” “comprising,” “includes,” and/or “including” when used in the disclosure, specify the presence of stated steps and elements, but do not preclude the presence or addition of one or more other steps and elements.

Some modules of the system may be referred to in various ways according to some embodiments of the present disclosure. However, any number of different modules may be used and operated in a client terminal and/or a server. These modules are intended to be illustrative, not intended to limit the scope of the present disclosure. Different modules may be used in different aspects of the system and method.

According to some embodiments of the present disclosure, flowcharts are used to illustrate the operations performed by the system. It is to be expressly understood, the operations above or below may or may not be implemented in order. Conversely, the operations may be performed in inverted order, or simultaneously. Besides, one or more other operations may be added to the flowcharts, or one or more operations may be omitted from the flowchart.

Technical solutions of the embodiments of the present disclosure are described with reference to the drawings as described below. It is obvious that the described embodiments are not exhaustive and are not limiting. Other embodiments obtained, based on the embodiments set forth in the present disclosure, by those with ordinary skill in the art without any creative works are within the scope of the present disclosure.

In an aspect, the present disclosure is directed to systems and methods for information processing. The system may classify a plurality of users into one or more primary user groups based on order information. If at least a part of the plurality of users send response information to the system in response to invitation information for joining a user group, and the response information may include confirmation information and user preferences. The system may further create one or more user secondary groups based on the response information.

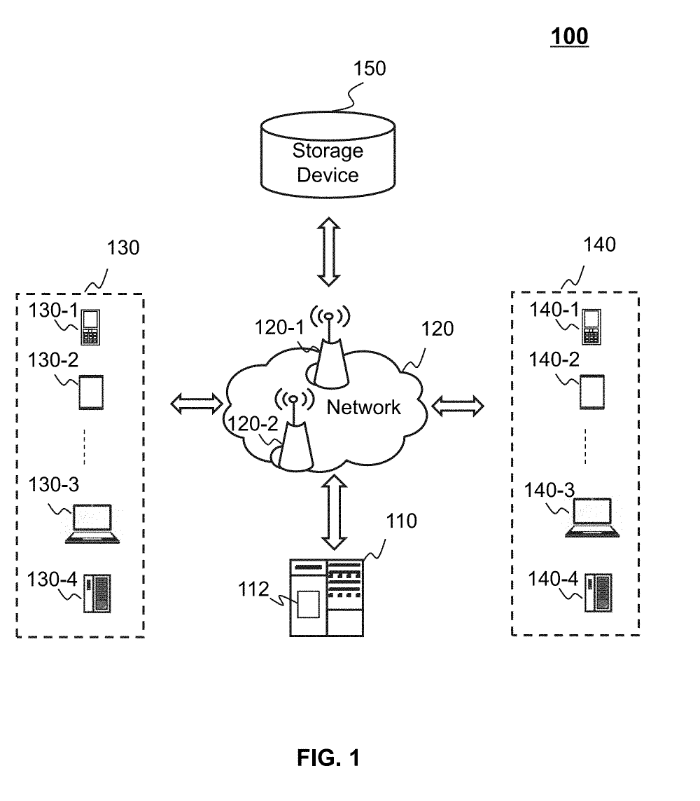

FIG. 1 is a schematic diagram illustrating an exemplary information processing system according to some embodiments of the present disclosure. For example, the information processing system 100 may be an online service platform for processing a service request from a user. In some embodiments, the service may be a transportation service, such as a taxi hailing service, a chauffeur service, a delivery vehicle service, a carpool service, a bus service, a driver hiring service and a shuttle service. In some embodiment, the service may be any online service, such as booking a meal, shopping, or the like, or any combination thereof. The system 100 may be an online platform including a server 110, a network 120, a requestor terminal 130, a provider terminal 140, and a storage device 150.

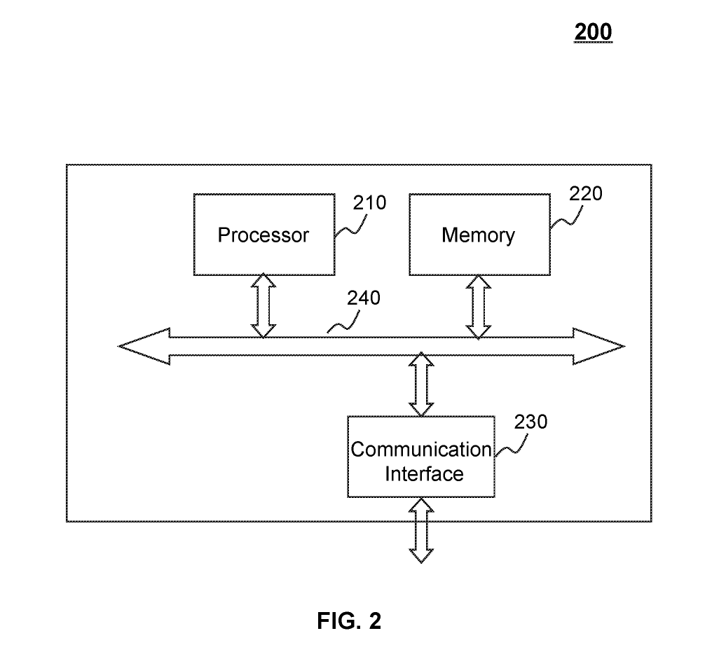

In some embodiments, the server 110 may be a single server or a server group. The server group may be centralized, or distributed (e.g., server 110 may be a distributed system). In some embodiments, the server 110 may be local or remote. For example, the server 110 may access information and/or data stored in the requestor terminal 130, the provider terminal 140, and/or the storage device 150 via the network 120. As another example, the server 110 may be directly connected to the requestor terminal 130, the provider terminal 140, and/or the storage 150 to access stored information and/or data. In some embodiments, the server 110 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, the server 110 may be implemented on a computing device 200 having one or more components illustrated in FIG. 2 in the present disclosure.

In some embodiments, the server 110 may include a processing engine 112. The processing engine 112 may process information and/or data relating to a service request to perform one or more functions described in the present disclosure. For example, the processing engine 112 may obtain order information from a plurality of users and classify the plurality of users into one or more user groups based on the obtained order information. In some embodiments, the processing engine 112 may include one or more processing engines (e.g., single-core processing engine(s) or multi-core processor(s)). Merely by way of example, the processing engine 112 may include one or more hardware processors, such as a central processing unit (CPU), an application-specific integrated circuit (ASIC), an application-specific instruction-set processor (ASIP), a graphics processing unit (GPU), a physics processing unit (PPU), a digital signal processor (DSP), a field-programmable gate array (FPGA), a programmable logic device (PLD), a controller, a microcontroller unit, a reduced instruction-set computer (RISC), a microprocessor, or the like, or any combination thereof.

The network 120 may facilitate the exchange of information and/or data. In some embodiments, one or more components in the system 100 (e.g., the server 110, the requestor terminal 130, the provider terminal 140, and/or the storage device 150) may send information and/or data to other component(s) in the system 100 via the network 120. For example, the server 110 may obtain/acquire service request from the requestor terminal 130 via the network 120. The service request may include a user grouping request. For example, the user may request to join a user group. In some embodiments, the network 120 may be any type of wired or wireless network, or a combination thereof. Merely by way of example, the network 130 may include a cable network, a wireline network, an optical fiber network, a telecommunications network, an intranet, the Internet, a local area network (LAN), a wide area network (WAN), a wireless local area network (WLAN), a metropolitan area network (MAN), a public telephone switched network (PSTN), a Bluetooth network, a ZigBee network, a near field communication (NFC) network, or the like, or any combination thereof. In some embodiments, the network 120 may include one or more network access points. For example, the network 120 may include wired or wireless network access points such as base stations and/or internet exchange points 120-1, 120-2, . . . , through which one or more components of the on-demand service system 100 may be connected to the network 120 to exchange data and/or information.

In some embodiments, a requestor may be a user of the requestor terminal 130. In some embodiments, the user of the requestor terminal 130 may be someone other than the requestor. For example, a user A of the requestor terminal 130 may use the requestor terminal 130 to send a service request for a user B, or receive service and/or information or instructions from the server 110. In some embodiments, a provider may be a user of the provider terminal 140. In some embodiments, the user of the provider terminal 140 may be someone other than the provider. For example, a user C of the provider terminal 140 may use the provider terminal 140 to receive a service request for a user D, and/or information or instructions from the server 110. In some embodiments, “requestor” and “requestor terminal” may be used interchangeably, “user” and “user terminal” may be used interchangeably, and “provider” and “provider terminal” may be used interchangeably.

In some embodiments, the requestor terminal 130 may include a mobile device 130-1, a tablet computer 130-2, a laptop computer 130-3, a built-in device in a motor vehicle 130-4, or the like, or any combination thereof. In some embodiments, the mobile device 130-1 may include a smart home device, a wearable device, a mobile device, a virtual reality device, an augmented reality device, or the like, or any combination thereof. In some embodiments, the smart home device may include a smart lighting device, a control device of an intelligent electrical apparatus, a smart monitoring device, a smart television, a smart video camera, an interphone, or the like, or any combination thereof. In some embodiments, the wearable device may include a bracelet, footgear, glasses, a helmet, a watch, clothing, a backpack, a smart accessory, or the like, or any combination thereof. In some embodiments, the mobile device may include a mobile phone, a personal digital assistance (PDA), a gaming device, a navigation device, a point of sale (POS) device, a laptop, a desktop, or the like, or any combination thereof. In some embodiments, the virtual reality device and/or the augmented reality device may include a virtual reality helmet, a virtual reality glass, a virtual reality patch, an augmented reality helmet, augmented reality glasses, an augmented reality patch, or the like, or any combination thereof. For example, the virtual reality device and/or the augmented reality device may include a Google Glass™, a RiftCon™, a Fragments™, a Gear VR™, etc. In some embodiments, a built-in device in the motor vehicle 130-4 may include an onboard computer, an onboard television, etc. In some embodiments, the requestor terminal 130 may be a device with positioning technology for locating the position of the requestor and/or the requestor terminal 130.

In some embodiments, the provider terminal 140 may be a device that is similar to, or the same as the requestor terminal 130. In some embodiments, the provider terminal 140 may be a device utilizing positioning technology for locating the position of a user of the provider terminal 140 (e.g., a service provider) and/or the provider terminal 140. In some embodiments, the requestor terminal 130 and/or the provider terminal 140 may communicate with one or more other positioning devices to determine the position of the requestor, the requestor terminal 130, the provider, and/or the provider terminal 140. In some embodiments, the requestor terminal 130 and/or the provider terminal 140 may send positioning information to the server 110.

The positioning technology used in the present disclosure may be based on a global positioning system (GPS), a global navigation satellite system (GLONASS), a compass navigation system (COMPASS), a Galileo positioning system, a quasi-zenith satellite system (QZSS), a wireless fidelity (WiFi) positioning technology, or the like, or any combination thereof. One or more of the above positioning systems may be used interchangeably in the present disclosure.

The storage device 150 may store data and/or instructions. In some embodiments, the storage device 150 may store data obtained from the requestor terminal 130 and/or the provider terminal 140. In some embodiments, the storage device 150 may store data and/or instructions that the server 110 may execute or use to perform exemplary methods described in the present disclosure. In some embodiments, the storage device 150 may include a mass storage, a removable storage, a volatile read-and-write memory, a read-only memory (ROM), or the like, or any combination thereof. Exemplary mass storage may include a magnetic disk, an optical disk, a solid-state drive, etc. Exemplary removable storage may include a flash drive, a floppy disk, an optical disk, a memory card, a zip disk, a magnetic tape, etc. Exemplary volatile read-and-write memory may include a random-access memory (RAM). Exemplary RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. Exemplary ROM may include a mask ROM (MROM), a programmable ROM (PROM), an erasable programmable ROM (EPROM), an electrically-erasable programmable ROM (EEPROM), a compact disk ROM (CD-ROM), and a digital versatile disk ROM, etc. In some embodiments, the storage 150 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the storage device 150 may be connected to the network 120 to communicate with one or more components in the on-demand service system 100 (e.g., the server 110, the requestor terminal 130, the provider terminal 140, etc.). One or more components in the system 100 may access the data or instructions stored in the storage device 150 via the network 120. In some embodiments, the storage device 150 may be directly connected to or communicate with one or more components in the on-demand service system 100 (e.g., the server 110, the requestor terminal 130, the provider terminal 140, etc.). In some embodiments, the storage 150 may be part of the server 110.

In some embodiments, one or more components in the system 100 (e.g., the server 110, the requestor terminal 130, the provider terminal 140, etc.) may have permission to access the storage device 150. In some embodiments, one or more components in the system 100 may read and/or modify information relating to the requestor, provider, and/or the public when one or more conditions are met. For example, the server 110 may read and/or modify one or more users' information after a service is completed. As another example, the provider terminal 140 may access information relating to the requestor when receiving a service request from the requestor terminal 130, but the provider terminal 140 may not modify the relevant information of the requestor.

In some embodiments, information exchanging of one or more components in the system 100 may be achieved by way of requesting a service. The object of the service request may be any product. In some embodiments, the product may be a tangible product or an immaterial product. The tangible product may include food, medicine, commodity, chemical product, electrical appliance, clothing, car, housing, luxury, or the like, or any combination thereof. The immaterial product may include a servicing product, a financial product, a knowledge product, an internet product, or the like, or any combination thereof. The internet product may include an individual host product, a web product, a mobile internet product, a commercial host product, an embedded product, or the like, or any combination thereof. The mobile internet product may be used in a software of a mobile terminal, a program, a system, or the like, or any combination thereof. The mobile terminal may include a tablet computer, a laptop computer, a mobile phone, a personal digital assistance (PDA), a smart watch, a point of sale (POS) device, an onboard computer, an onboard television, a wearable device, or the like, or any combination thereof. For example, the product may be any software and/or application used in the computer or mobile phone. The software and/or application may relate to socializing, shopping, transporting, entertainment, learning, investment, or the like, or any combination thereof. In some embodiments, the software and/or application relating to transporting may include a traveling software and/or application, a vehicle scheduling software and/or application, a mapping software and/or application, etc. In the vehicle scheduling software and/or application, the vehicle may include a horse, a carriage, a rickshaw (e.g., a wheelbarrow, a bike, a tricycle, etc.), a car (e.g., a taxi, a bus, a private car, etc.), a train, a subway, a vessel, an aircraft (e.g., an airplane, a helicopter, a space shuttle, a rocket, a hot-air balloon, etc.), or the like, or any combination thereof.

One of ordinary skill in the art would understand that when an element of the system 100 performs, the element may perform through electrical signals and/or electromagnetic signals. For example, when a requestor terminal 130 processes a task, such as making a determination, identifying or selecting an object, the requestor terminal 130 may operate logic circuits in its processor to process such task. When the requestor terminal 130 sends out a service request to the server 110, a processor of the service requestor terminal 130 may generate electrical signals encoding the service request. The processor of the requestor terminal 130 may then send the electrical signals to an output port. If the requestor terminal 130 communicates with the server 110 via a wired network, the output port may be physically connected to a cable, which may further transmit the electrical signals to an input port of the server 110. If the requestor terminal 130 communicates with the server 110 via a wireless network, the output port of the requestor terminal 130 may be one or more antennas, which may convert the electrical signals to electromagnetic signals. Similarly, a provider terminal 140 may process a task through operation of logic circuits in its processor, and receive an instruction and/or service request from the server 110 via electrical signals or electromagnet signals. Within an electronic device, such as the requestor terminal 130, the provider terminal 140, and/or the server 110, when a processor thereof processes an instruction, sends out an instruction, and/or performs an action, the instruction and/or action is conducted via electrical signals. For example, when the processor retrieves or saves data from a storage medium (e.g., the storage device 150), it may send out electrical signals to a read/write device of the storage medium, which may read or write structured data in the storage medium. The structured data may be transmitted to the processor in the form of electrical signals via a bus of the electronic device. Here, an electrical signal may refer to one electrical signal, a series of electrical signals, and/or a plurality of discrete electrical signals.

FIG. 2 is a schematic diagram illustrating exemplary components of a computing device according to some embodiments of the present disclosure. The server 110, the driver terminal 120, and/or the storage device 130 may be implemented on the computing device 200 according to some embodiments of the present disclosure. The particular system may use a functional block diagram to explain the hardware platform containing one or more user interfaces. The computer may be a computer with general or specific functions. Both types of the computers may be configured to implement any particular system according to some embodiments of the present disclosure. The computing device 200 may be configured to implement any components that perform one or more functions disclosed in the present disclosure. For example, the computing device 200 may implement any component of the system 100 as described herein. In FIGS. 1 and 2, only one such computer device is shown purely for convenience purposes. One of ordinary skill in the art would understand at the time of filing of this application that the computer functions relating to the service as described herein may be implemented in a distributed fashion on a number of similar platforms, to distribute the processing load.

As shown in FIG. 2, the computing device 200 may include a processor 210, a memory 220, a communication interface 230 and a communication bus 240. The processor 210, the memory 220 and the communication interface 230 may exchange information and/or data with each other via the communication bus 240. In some embodiments, the communication interface 230 may be configured to facilitate data communications between the computing device 200 and other (e.g., the requestor terminal 130 or the provider terminal 140) components.

The processor 210 may invoke a set of instructions stored in the memory 220 to perform exemplary methods or processes described in the present disclosure. For example, the processor may obtain order information of at least one current processing order from a plurality of users. The processor may classify the plurality of users into one or more user groups based on the order information. The processor may send invitation information for joining a user group to each of the plurality of users of the one or more user groups. The processor may receive response information associated with the invitation information from at least a part of the plurality of users, and add the at least a part of the plurality of users into the user groups based on the response information.

The processor 210 may include interface circuits and processing circuits therein. The interface circuits may be configured to receive electronic signals from the bus 240, wherein the electronic signals encode structured data and/or instructions for the processing circuits to process. The processing circuits may conduct logic calculations, and then determine a conclusion, a result, and/or an instruction encoded as electronic signals. Then the interface circuits may send out the electronic signals from the processing circuits via the bus 240.

The exemplary memory 220 may include program storage, and/or data storage of different forms including, for example, a disk, and a read-only memory (ROM), or a random-access memory (RAM), for various data files to be processed and/or transmitted by the computing device 200. The processor 210 may execute program instructions stored in the memory 220, and/or another type of non-transitory storage medium. The methods and/or processes of the present disclosure may be implemented as the program instructions. In some embodiments, the computing device 200 may also receive programming and data via network communications.

Merely for illustration, only one processor is illustrated in FIG. 2. Multiple CPUs and/or processors are also contemplated; thus operations and/or method steps performed by one CPU and/or processor as described in the present disclosure may also be jointly or separately performed by the multiple CPUs and/or processors. For example, if in the present disclosure the CPU and/or processor of the computing device 200 executes both step A and step B, it should be understood that step A and step B may also be performed by two different CPUs and/or processors jointly or separately in the computing device 200 (e.g., the first processor executes step A and the second processor executes step B, or the first and second processors jointly execute steps A and B).

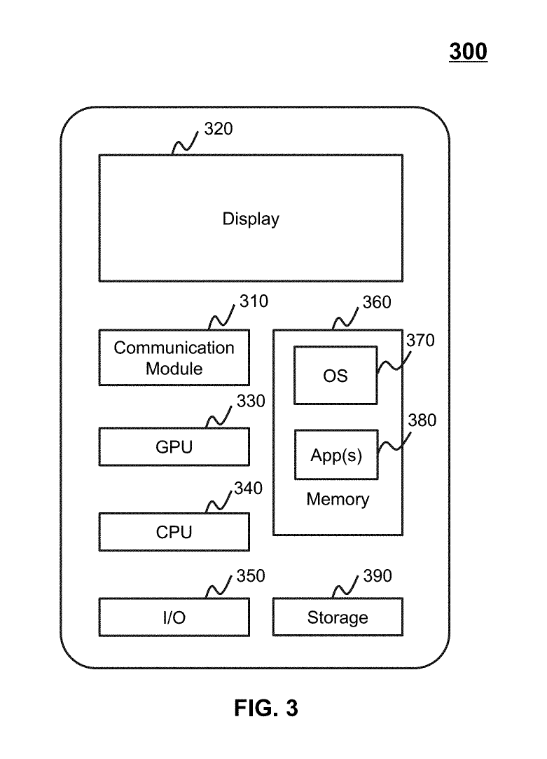

FIG. 3 is a block diagram illustrating exemplary hardware and/or software components of an exemplary mobile device according to some embodiments of the present disclosure. The requestor terminal 130 may be implemented on the mobile device 300 according to some embodiments of the present disclosure. As illustrated in FIG. 3, the mobile device 300 may include a communication module 310, a display 320, a graphics processing unit (GPU) 330, a central processing unit (CPU) 340, an I/O 350, a memory 360, and a storage 390. The CPU 340 may include interface circuits and processing circuits similar to the processor 210. In some embodiments, any other suitable component, including but not limited to a system bus or a controller (not shown), may also be included in the mobile device 300. In some embodiments, a mobile operating system 370 (e.g., iOS™, Android™ Windows Phone™) and one or more applications 380 may be loaded into the memory 360 from the storage 390 in order to be executed by the CPU 340. The applications 380 may include a browser or any other suitable mobile apps for transmitting the trajectory data to the server 110. User interaction with the information stream may be achieved via the I/O devices 350 and provided to the processing engine 112 and/or other components of the system 100 via the network 120.

In order to implement various modules, units and their functions described above, a computer hardware platform may be used as hardware platforms of one or more elements (e.g., a component of the server 110 described in FIG. 1). Since these hardware elements, operating systems, and program languages are common, it may be assumed that persons skilled in the art may be familiar with these techniques and they may be able to provide information required in the traffic lights controlling according to the techniques described in the present disclosure. A computer with user interface may be used as a personal computer (PC), or other types of workstations or terminal devices. After being properly programmed, a computer with user interface may be used as a server. It may be considered that those skilled in the art may also be familiar with such structures, programs, or general operations of this type of computer device. Thus, extra explanations are not described for the figures.

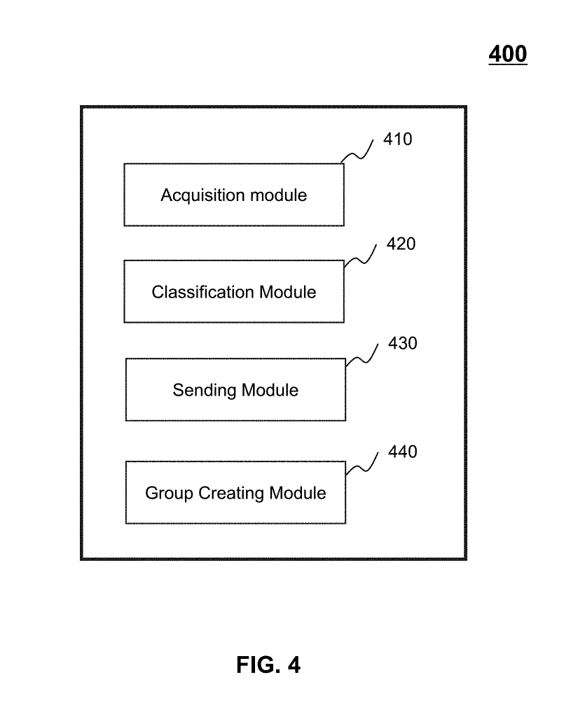

FIG. 4 is a block diagram illustrating an exemplary processing engine according to some embodiments of the present disclosure. The processing engine 112 may include an acquisition module 410, a classification module 420, a sending module 430, and a group creating module 440.

The modules may be hardware circuits of at least part of the processing engine 112. The modules may also be implemented as an application or set of instructions read and executed by the processing engine 112. Further, the modules may be any combination of the hardware circuits and the application/instructions. For example, the modules may be the part of the processing engine 112 when the processing engine 112 is executing the application/set of instructions.

The acquisition module 410 may obtain order information of service orders from a plurality of users.

Merely for illustration purposes, a user may send a service order to the server 110 via the network 120, and the service order may be stored in a storage (e.g., the storage device 150, or the memory 220). The processor (e.g., the acquisition module 410) may obtain order information of the service order form the storage. The order information may include but not limited to a start location, a destination, a user ID, a user gender, etc. In some embodiments, the service order may be a real time order. For example, the acquisition module 410 may directly obtain the service order in real time from a user, and the obtained service order may be a real time order.

The classification module 420 may classify the plurality of users into one or more user groups based on the order information. In some embodiments, one of the one or more user groups may also be referred to as a primary user group. The primary user group may refer to a group of users having a same or similar destination and/or remaining travelling time (also referred to as “travelling time”). The travelling time may refer to a duration in which a user travels from his/her current location to his/her destination. For one or more users who have started their journey, if they have a same or similar travelling time, it may indicate that the one or more users may arrive at their destinations at a same or similar time. In some embodiments, the classification module 420 may classify the plurality of users into one or more primary user groups based on the destinations and/or travelling time of the plurality of users.

For example, the classification module 420 may obtain destinations of the plurality of users based on the order information. The classification module 420 may determine a distance between destinations of any two of the plurality of users. The classification module 420 may determine the one or more user groups by comparing the distance with a threshold, and classify at least a part of the plurality of users into a primary user group (also referred to as “destination group”) based on the comparison.

As another example, the classification module 420 may obtain current locations and destinations of the plurality of users based on the order information. The classification module 420 may determine a traveling time for each of the plurality of users based on the current locations and corresponding destinations. The classification module 420 may determine traveling time differences between any two of the plurality of users, and determine absolute values of the traveling time differences. Then the classification module 420 may determine one or more user groups by comparing the absolute values with a threshold, and classify the plurality of users into one or more primary user groups (also referred to as “time group”) based on the comparison.

The sending module 430 may send invitation information for joining a corresponding user group to each of the plurality of users. In some embodiments, the processor may send the invitation information in form of a message using any suitable communication protocol via the network 120. The suitable communication protocol may include Hypertext Transfer Protocol (HTTP), Address Resolution Protocol (ARP), Dynamic Host Configuration Protocol (DHCP), File Transfer Protocol (FTP).

The group creating module 440 may receive response information associated with the invitation information from at least a part of the plurality of users, create one or more user groups based on the response information, and add the at least a part of the plurality of users into corresponding user groups. Merely for illustration purposes, the group creating module 440 may receive confirmation information for joining a user group and user preferences from a plurality of users of a destination group. The group creating module 440 may determine a user set that includes the plurality of users who agree to join a user group (i.e., who have sent the confirmation information). The group creating module 440 may create one or more secondary user groups based on the at least a part of the plurality of users of the user set that satisfy the user preference to a same secondary user group. In some embodiments, the user preference information may include gender information and the number of users in a user group.

In some embodiments, the group creating module 440 may receive exit information from a user of the one or more users for seceding from a user group, and remove the user out of the user group accordingly.

It should be noted that the above description of the processing engine 112 is merely provided for the purposes of illustration, and not intended to limit the scope of the present disclosure. For persons having ordinary skills in the art, multiple variations and modifications may be made under the teachings of the present disclosure. For example, the processing engine 112 may further include a storage module to facilitate data storage. However, those variations and modifications do not depart from the scope of the present disclosure.

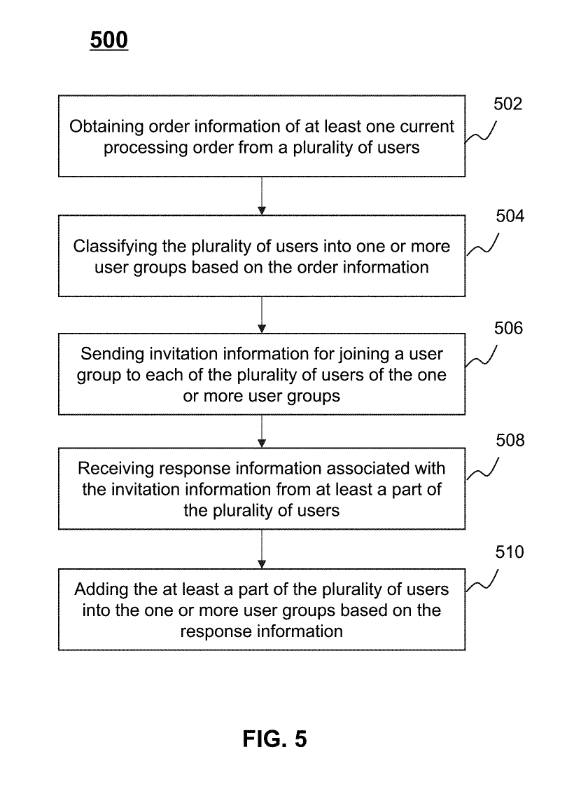

FIG. 5 is a flowchart illustrating an exemplary process for creating user groups according to some embodiments of the present disclosure. In some embodiments, the process 500 may be implemented in the information processing system 100. For example, the process 500 may be stored in the storage device 150 and/or the storage (e.g., the memory 220) as the form of instructions, and invoked and/or executed by the server 110 (e.g., the processing engine 112 being in the server 110, or the processor 210 of the computing device 200).

In 501, the processor (e.g., the acquisition module 410) may obtain order information of at least one current service order from a plurality of users.

It should be noted that the processor (e.g., the processing engine 112 of the server 110, or the processor 210) may perform operations 502-510. In some embodiments, a user may send a service request in forms of a service order (also referred as a “current service order”) via a user terminal (e.g., the requestor terminal 130) to at least one driver (or the provider terminal 140 of the at least one driver). After a driver receives the service order, the requestor terminal 130 may send order information of the service order to the server 110. The state of the current service order may be switched to an “under processing” state, which indicates that the server 110 is processing the service order. If the user arrives at the destination of the service order, the state of the service order may be switched to a “complete” state, which indicates that the driver has complete a journey of the service order. In some embodiments, after a driver receives the service order, the driver terminal (e.g., the provider terminal 140) may send order information of the received service order to the server 110. The state of the current service order may be switched to an “under processing” state, which indicates that the server 110 is processing the service order. If the driver takes the user to the destination of the service order, the state of the service order may be switched to a “complete” state, which indicates that the driver has complete a journey of the service order.

In some embodiments, the processor may obtain order information from a plurality of users. Merely for illustration purposes, a user may send a service order to the server 110 via the network 120, and the service order may be stored in a storage (e.g., the storage device 150, or the memory 220). The processor (e.g., the acquisition module 410) may obtain order information of the service order from the storage. The order information may include but not limited to a start location, a destination, a user ID, a user gender, etc. In some embodiments, the service order may be a real time order. For example, the server 110 may directly obtain the service order in real time from a user, and the obtained service order may be a real time order.

In 504, the processor (e.g., the classification module 420) may classify the plurality of users into one or more user groups based on the order information.

After the processor obtains the order information of the service orders from the plurality of users, the processor may classify the plurality of users into one or more user groups based on the order information. In some embodiments, one of the one or more user groups may be also referred to as a primary user group. For example, the processor may classify one or more users into a same primary user group when distances between destinations of any two of the one or more users are less than a certain threshold (i.e., a distance value, such as 0.5 km, 3 km, 6 km, etc.). In this case, the classified primary user group may also be referred to as a destination group. The distances between destinations of any two of the one or more users of the same destination group may be less than the certain threshold. As another example, the processor may classify one or more users into the same primary user group when differences of traveling time between any two of the one or more of users are less than a certain threshold (i.e., a time duration, such as 3 minutes, 5 minutes, 10 minutes, etc.). In this case, the classified primary user group may also be referred to as a time group. The differences of traveling time between any two of the one or more of users of the same time group may be less than the certain threshold.

In some embodiments, the processor may also further classify at a least part of the plurality of users of the classified primary user groups into one or more user groups based on requests of the plurality of users, such as a user's preferences. The user preferences may include gender information and the number of users in a user group. For example, if a user requests to join a user group in which most of the group members are females, the processor may classify the plurality of users who are female into a same user group.

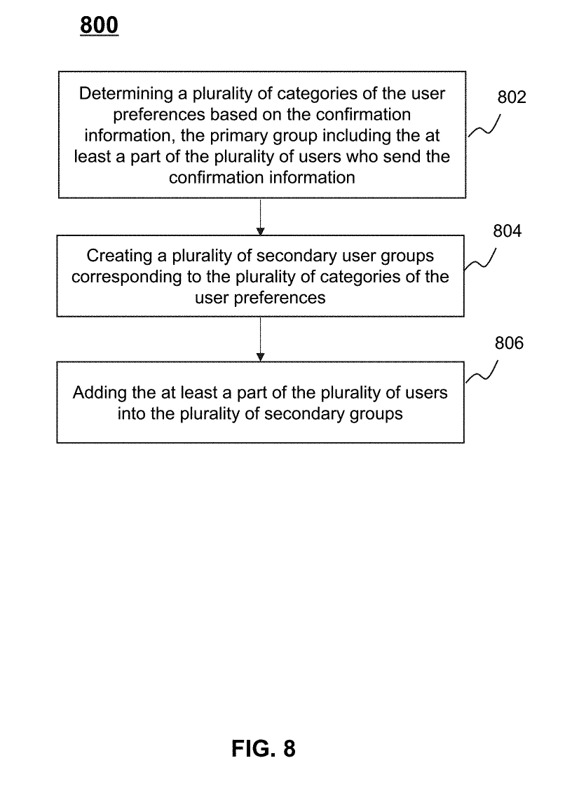

In some embodiments, a primary user group may be a destination group or a time group. As used herein, the destination group may refer to a user group for which distances between destinations of any two users are less than a preset threshold. The time group may refer to a user group for which differences of traveling time between any two users are less than a preset threshold. The processor may determine the travelling time of a user based on the order information (e.g., a current location and a destination). In some embodiments, the processor (e.g., the group creating module 440) may create one or more secondary user groups based on the primary user groups. The secondary user group may refer to a subgroup of the primary user group. Merely by ways of example, users in the primary user group may be reclassified into one or more secondary groups according to the users' preferences (e.g., preferences in the number of users in a user group, education background of users in a group, etc.). More descriptions regarding the creation of a secondary user group may be found elsewhere in the present disclosure (e.g., FIG. 8 and the description thereof).

In 506, the processor (e.g., the sending module 430) may send invitation information for joining a user group to each of the plurality of users of the one or more user groups.

After the plurality of users are classified into the one or more primary user groups, the processor may send invitation information for joining a user group to each of the plurality of users of the one or more primary user groups. The user terminals (e.g., the requestor terminal 130) of the plurality of users may receive the invitation information, and display the invitation information on the display (e.g., the display 320). In some embodiments, the processor may send the invitation information in a form of a message using any suitable communication protocol via the network 120. The suitable communication protocol may include Hypertext Transfer Protocol (HTTP), Address Resolution Protocol (ARP), Dynamic Host Configuration Protocol (DHCP), File Transfer Protocol (FTP).

If a user of the one or more primary user groups agrees to join a user group indicated in the invitation information, it may indicate that the processor may add the user into the corresponding user group. Merely for illustration purposes, the invitation information may be a message like “Would you like to join a user group? Yes or No”. If the user chooses “Yes”, it may indicate that the user agrees to join the user group. If the user chooses “No”, the use refuses to join the user group.

In 508, the processor (e.g., the group creating module 440) may receive response information associated with the invitation information from at least a part of the plurality of users.

After the plurality of users receive the invitation information, at least a part of the plurality of users who agree to join a user group may send response information to the server 110. In some embodiments, the response information may include confirmation information and those users' preferences. The confirmation information may indicate that a user agrees to join the user group associated with the invitation information. The user preference information may include gender information and the number of users in a user group.

In some embodiments, the user may send the response information in a form of a message using any suitable communication protocol via the network 120. The suitable communication protocol may include Hypertext Transfer Protocol (HTTP), Address Resolution Protocol (ARP), Dynamic Host Configuration Protocol (DHCP), File Transfer Protocol (FTP). In some embodiments, the user may determine the response information by filling out a pop-up dialog box. For example, the user may set the user preference in the pop-up dialog box on a display (e.g., the display 320) of a user terminal (e.g., the requestor terminal 130). After the response information is complete, the user may send the response information to the processor (e.g., via the requestor terminal 130). In some embodiments, the user may set the user preference after the user sends the confirmation information.

In 510, the processor may add at least a part of the plurality of users into the one or more user groups based on the response information.

Merely for illustration purposes, the processor may classify one or more users into a first destination group. The processor may send first invitation information for joining a user group (e.g., a user group A) to each of the one or more users of the first destination group. If a part of the one or more users of the first destination group send the confirmation information for joining the user group A to the server 110 or the processor 210, the processor may add the part of the one or more users into the user group. In some embodiments, the response information may also include those users' preferences, the processor may further create secondary user groups based on the users' preferences. For example, the processor may classify the users' preferences into a plurality of categories, and determine the secondary user groups based on the plurality of categories of the users' preferences. More descriptions about determining the secondary user group may be found elsewhere in the present disclosure (e.g., FIG. 8 and the description thereof).

In the process 500 illustrated in FIG. 5, the processor may classify the plurality of users of a primary user group into one or more sub-groups (i.e., secondary user groups) based on order information associated with the plurality of users. The primary user group may include a destination group or a time group. In some embodiments, the users of the user group classified from the time group may have a similar or the same travelling time that each user travels from a current location to a destination. In some embodiments, the users of the user group classified into the destination group may have similar or the same destinations. In some embodiments, the users in the same user group may chat in groups, for example, share location information, the license number of the vehicle, and/or driver information, or the like, or any combination thereof with each other. Thus the users in the same user group may monitor each other's security status during their travelling.

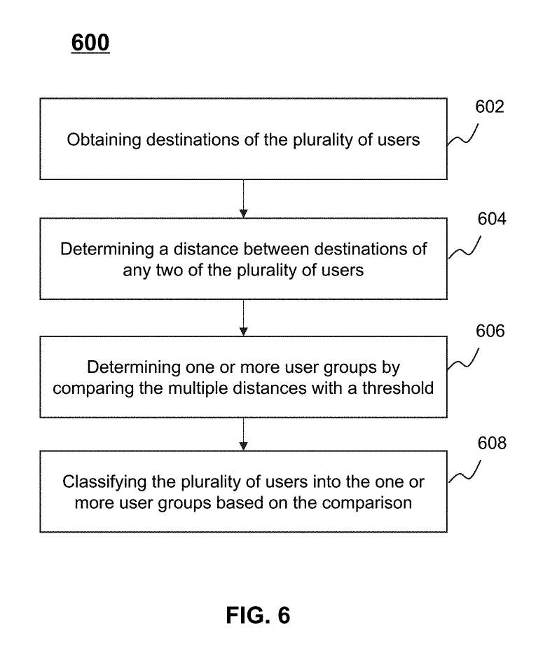

FIG. 6 is a flowchart illustrating an exemplary process for classifying a plurality of users into one or more user groups according to destinations of the plurality of users according to some embodiments of the present disclosure. In some embodiments, the process 600 may be implemented in the information processing system 100. For example, the process 600 may be stored in the storage device 150 and/or the storage (e.g., the memory 220) as the form of instructions, and invoked and/or executed by the server 110 (e.g., the processing engine 112 in the server 110, or the processor 210 of the computing device 200).

In 602, the processor (e.g., the classification module 420) may obtain destinations of the plurality of users based on order information from the plurality of users.

In some embodiments, the processor may obtain a plurality of real time orders from the plurality of users. The processor may directly obtain the service order in real time from a user, and the obtained service order may be a real time order. The real time order may relate to a transportation service, such as a taxi hailing service, a carpool service, or the like. In some embodiments, order information of a real time order may include a start location, a destination, a user's ID, a user's gender, or the like, or any combination thereof. In some embodiments, the order information may be stored in a storage (e.g., the storage device 150, or the memory 220). The processor may obtain destinations of the plurality of users that included in the order information from the storage.

In 604, the processor (e.g., the classification module 420) may determine a distance between the destinations of any two of the plurality of users.

For example, a first destination of a first user is location A, a second destination of a second user is location B, the processor may determine the distance from the first destination to the second destination as a distance difference between the location A and the location B (e.g., 0.9 kilometers, 3 kilometers, etc.). Similarly, the processor may determine multiple distances between any two destinations of the plurality of users. The determined multiple distances may be stored in the storage devcie 150.

In 606, the processor (e.g., the classification module 420) may determine one or more user groups by comparing the distance with a first threshold. The first threshold may be a predetermined distance value, such as 3 kilometers, 5 kilometers, 6 kilometers, and so on. The first threshold may be set by a user (e.g., a technician), according to default settings of the information processing system 100. In some embodiments, the information processing system 100 may adjust the first threshold based on the number of service orders dynamically. If the processor 210 obtains too many service orders in a time period, the processor 210 may adjust the first threshold to a smaller value. For example, the processor 210 may adjust the first threshold from 5 kilometers to 3 kilometers. The processor may store the first threshold in a storage (e.g., the storage device 150). The processor may obtain the first threshold from the storage.

In 608, the processor (e.g., the classification module 420) may classify the plurality of users into the one or more user groups based on the comparison.

In some embodiments, the processor may perform an inquiry operation for determining destination groups. To perform the inquiry operation, the processor may obtain a destination A of the user A as indicated in a service order, and add the user A into a destination group A. Then the processor may inquire about a plurality of destinations corresponding to a plurality of real time service orders from a plurality of users, and obtain one or more destinations from the plurality of destinations that a distance between the destination A and each of the one or more destinations is less than or equal to the first threshold. If the one or more users corresponding to the obtained one or more destinations are not in the destination group A, the processor may add the one or more users into the destination group A.

In some embodiments, the processor may repeat the inquiry operation for a plurality of times. When the processor adds all users, who satisfy preset conditions, for example, distances between destinations of the users and a certain destination (e.g., the destination A) is less than or equal to the first threshold, to the same destination group (e.g., the destination group A), the processor may terminate the inquiry operation.

In some embodiments, the processor may obtain order information including destinations of a plurality users, and determine a circle on a map including the destinations. The diameter of the circle may equal to the first threshold. The center of the circle may be a destination (e.g., the destination A). The processor may determine one or more destinations within the circle, and add one or more users corresponding to the one or more destinations into a destination group.

For example, the processor may obtain a service order A from a user A, and obtain a destination A of the user A based on order information of the service order A. The processor may determine a first circle on a map. The center of the first circle may be the destination A, and the diameter of the first circle may be the first threshold. The processor may determine one or more first destinations within the first circle on the map. The processor may classify one or more users corresponding to the one or more first destinations into a first destination group. Similarly, the processor may determine a second circle on the map. The center of the second circle is the destination B, and the diameter of the second circle may also be the first threshold. The processor may determine one or more second destinations within the second circle on the map. The processor may classify one or more users corresponding to the one or more second destinations into a second destination group. It should be understood that the processor may determine one or more destination groups in a way similar to the first destination group or the second destination group are determined.

In some embodiments, the processor may classify the destinations of the plurality of users into one or more groups, and then create one or more user groups (i.e., primary user groups) corresponding to the one or more groups, respectively. Then the processor may add the plurality of users into the one or more user groups.

It is should be understood that classifying users into users group based on the difference in their destination may be able to improve a travel safety because a user in the same destination group may be familiar with surrounding environment around his/her destination. Safety of users in the same user group may be improved by sharing information (e.g., location information) with each other. For example, suppose that the user A and the user B are in the same destination group, the user A may share his/her location information with the user B, and the user B may determine whether the user A takes a correct route to the destination based on the shared location information. If the user B determines that the user A deviates from the correct route, the user B may send a warning message to the user A. As such, users in the same destination group may caution each other by sharing location information.

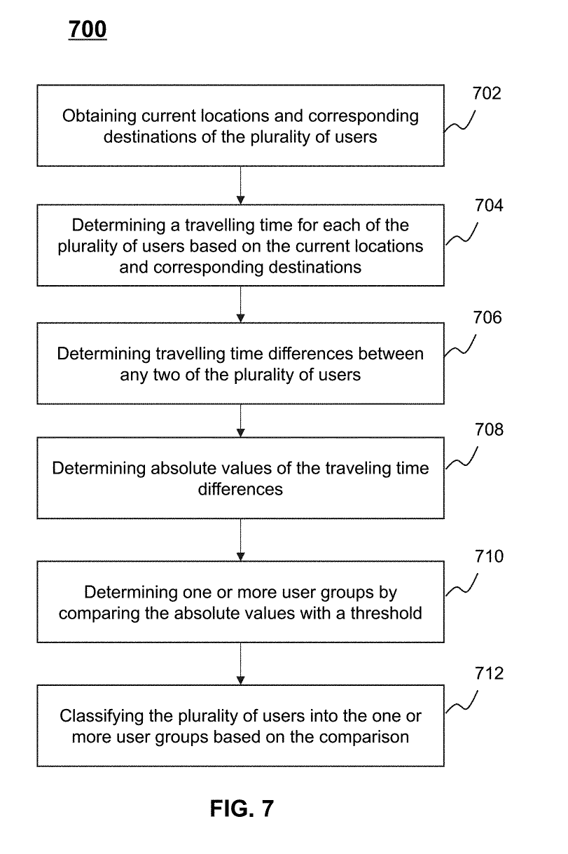

FIG. 7 is a flowchart illustrating an exemplary process for classifying a plurality of users into one or more groups according to travelling time of the plurality of users according to some embodiments of the present disclosure. In some embodiments, the process 700 may be implemented in the xxx system 100. For example, the process 700 may be stored in the storage device 150 and/or the storage (e.g., the memory 220) as the form of instructions, and invoked and/or executed by the server 110 (e.g., the processing engine 112 in the server 110, or the processor 210 of the computing device 200).

In 702, the processor (e.g., the classification module 420) may obtain current locations and corresponding destinations of a plurality of users.

In some embodiments, the processor may obtain the current locations of the plurality of users from user terminals (e.g., the requestor terminal 130) of the plurality of users. For example, the requestor terminal 130 of a user may communicate with a positioning system (e.g., GPS system). The positioning system may obtain the current location of the requestor terminal 130. The requestor terminal 130 may send the current location of the requestor terminal 130 to the server 110 (e.g., the processing engine 112 or the processor 210). The processor may obtain the current location of the requestor terminal 130, and determine the current location of the requestor terminal 130 as the current location of the user.

In some embodiments, the processor may obtain the destinations of the plurality of users, for example, based on order information of service orders of the plurality of users. The order information may include a start location, a destination, a user's ID, a user's gender, or the like, or any combination thereof.

In 704, the processor (e.g., the classification module 420) may determine a travelling time for each of the plurality of users based on the current locations and corresponding destinations of the plurality of users. For example, the processor may determine a route that a user travels from a current location to a destination, and determine a distance of the route. The processor may also determine a speed that the user travels from the current location and the destination. The processor may determine the travelling time that the user travels from the current location to the destination by dividing the distance by the speed of the vehicle ride by the user.

In some embodiments, after the processor receives a service order, the processor may plan a route from the start location or the current location to the destination. The route may be stored in a storage (e.g., the storage device 150). The processor may obtain the route from the current location to the destination from the storage. In some embodiments, the processor may obtain the route from the current location to the destination from a third party database (e.g., a map server). The processor may determine the distance of the route.

In some embodiments, the processor may determine the speed of the vehicle ridden by the user based on historical track data from the current location to the destination. The historical track data may relate to historical speeds of a plurality of vehicles (e.g., taxies) travelling from the current location to the destination. The processor may determine an average speed of the historical speeds. The processor may designate the average speed as the speed that the user travels from the current location to the destination.

In some embodiments, the processor may determine the travelling time from the current location to the destination from a third party database (e.g., a map server). For example, a map server may provide route planning and/or a travelling time for a current location to the destination. The processor may directly obtain the travelling time of the user from the map server.

In 706, the processor (e.g., the classification module 420) may determine travelling time differences between any two of the plurality of users.

In 708, the processor (e.g., the classification module 420) may determine absolute values of the determined travelling time differences, respectively.

In 710, the processor (e.g., the classification module 420) may determine one or more user groups by comparing the absolute values with a second threshold. The second threshold may be a predetermined time duration, such as 3 minutes, 5 minutes, 10 minutes, and so on. The second threshold may be set by a user (e.g., a technician), according to default settings of the information processing system 100. In some embodiments, the information processing system 100 may adjust the second threshold based on the number of service orders dynamically. If the processor 210 obtains too many service orders at a time period, the processor 210 may adjust the second threshold to a smaller time duration. For example, the processor 210 may adjust the first threshold from 5 minutes to 3 minutes. The processor may store the second threshold in a storage (e.g., the storage device 150), and obtain the second threshold from the storage.

In 712, the processor (e.g., the classification module 420) may classify the plurality of users into the one or more user groups based on the comparison.

In some embodiments, the processor may perform an inquiry operation for determining one or more time groups. To perform the inquiry operation, the processor may obtain a travelling time A of a user A as indicated in a service order, and add the user A in a time group A. Then the processor may inquiry a plurality of travelling times corresponding to a plurality of real time service orders from a plurality of users, and obtain one or more travelling times from the plurality of travelling times that the absolute value of travelling time difference between the travelling time A and each of the one or more travelling times is less than or equal to the second threshold. If the one or more users corresponding to the obtained one or more travelling times may not be in the time group A, the processor may add the one or more users into the time group A.

In some embodiments, the processor may classify the travelling times of the plurality of users into one or more groups, and then create one or more user groups (i.e., primary user groups) corresponding to the one or more groups, respectively. Then the processor may add the plurality of users into the one or more user groups.

Classifying users into user groups based on close remaining travel times may be able to improve a travel safety. Otherwise, if when other users arrive at their destinations, only few users (e.g., one or two users) may remain in the user group, they may not able to monitor each other's safety effectively. For example, when the other users all arrive at their destinations, only one user remains in the user group, no one in the same user group may monitor him/her safety. To avoid this problem, the processor may create a time group as mentioned above. For example, the users' travelling times in the time group may be the same or close. In this way, the users in the same time group can exit the user group at the same time.

It should be noted that the above description about the inquiry operation is merely provided for the purposes of illustration, and not intended to limit the scope of the present disclosure. For those skilled in the art, the inquiry operation may be varied. For example, the processor may perform the inquiry operation as illustrated in FIG. 6 or FIG. 7 independently. As another example, the processor may perform the inquiry operation as illustrated in FIG. 6 and FIG. 7 in parallel. All such variations are within the protection scope of the present disclosure.

In some embodiments, the processor (e.g., the sending module 430) may send invitation information for joining a user group to each of the plurality of users of the one or more user groups (i.e., the primary user groups). The processor may receive confirmation information for joining the user group sent by a first part of users of the plurality of users of the primary user group. The primary user group may include a destination group or a time group. The processor may determine a user set that includes the first part of users of the plurality of users. The user set may refer to a set that includes at least a part of a plurality of users of that send the confirmation information. The processor may select a second part of users of the user set that having the same user preferences from the first part of users, and add the second part of users into a secondary user group. It should be understood that the processor may create a plurality of secondary user groups after the processor receives the response information that includes the confirmation information and the user preference. The user preference may include gender information, the number of users in a user group, and/or other information of user group members (e.g., age, career, health, education background, smokers, etc.) in the secondary user group. More descriptions about creating the secondary user group may be found elsewhere in the present disclosure (e.g., FIG. 8 and the descriptions thereof.)

In some embodiments, the user preference may indicate information of a desired user group (e.g., a secondary user group) which a user wants to join. In some embodiments, the user preference information may include gender information of the desired user group. For example, the user wants to join a user group in which all the members of the user group are males or females. In some embodiments, the user preference may include the number of members of the desired user group. For example, a user wants to join a user group having two group members. In some embodiments, the user may send the user preference together with the confirmation information for joining a user group to the server 110 or the processor 210. For example, before a user sends out confirmation information, the user terminal (e.g., the requestor terminal 130) may pop up an interface (e.g., a dialog box) that reminds the user to join a user group. The user may input his or her preference (e.g., the members' gender or the number of members) via the interface. The user may send the confirmation information and the user preference to the server 110 via the requestor terminal 130.

It should be noted that a user may not input the user preference information on the pop-up interface. In some embodiments, for a user who does not input the user preference information, the processor may randomly assign the user to a user group.

FIG. 8 is a flowchart illustrating an exemplary process for creating user groups based on users' preferences according to some embodiments of the present disclosure. In some embodiments, the process 800 may be implemented in the system 100. For example, the process 800 may be stored in the storage device 150 and/or the storage (e.g., the memory 220) as the form of instructions, and invoked and/or executed by the server 110 (e.g., the processing engine 112 in the server 110, or the processor 210 of the computing device 200).

In 802, the processor (e.g., the group creating module 440) may determine a plurality of categories of the users' preferences based on the response information.

The processor may determine a plurality of categories of the users' preferences based on the response information. The response information may include confirmation information and/or user preferences. The users' preferences may include gender information, the number of users in a user group, and/or other information of user group members (e.g., age, career, health, education background, smokers, etc.) in the user group.

The processor may determine a first plurality of categories of the gender information based on the response information. The processor may obtain the gender information from the response information, and determine the first plurality of categories based on the gender information. For example, the processor may category the gender information that all the members of a user group are males into a first category. The processor may category the gender information that all the members of a user group are females into a second category. In some embodiments, a category may correspond to same gender information.

The processor may determine a second plurality of categories of the number of users based on the response information. The processor may obtain the number of users in a user group from the response information, and determine the second plurality of categories based on the number of users. For example, the processor may category the users preferring the group having 6 members into a second category. The processor may category the users who prefer the group having 7 members into a second category. In some embodiments, a category may correspond to the same number of user in a user group.

In some embodiments, the processor may determine the plurality of categories of the user preferences based on the first plurality of categories of the gender information and the second plurality of categories of the user number. For example, provided that gender information can be categorized into two categories including a first category that the members of a user group are males and a second category that the members of a user group are females. The user preferences on the number of users in a group can be categorized into three categories including a first category that the number of members of a user group is 2-5, a second category that the number of members of a user group is 6-9, a third category that the number of members of a user group is greater than or equal to 10. Then the processor may determine six categories of user preferences based on the gender information and the number of users in a group.

In 804, the processor (e.g., the group creating module 440) may create a plurality of secondary user groups corresponding to the plurality of categories of the users' preferences. For example, the processor determines a category A of users' preferences which requires five male members in a user group. The processor may create a secondary user group A corresponding to the category A, and the secondary user group A may include five male members. The processor determines a category B of the number of users which requires three male members and two female members in a user group. The processor may create a secondary user group B corresponding to the category A, and the secondary user group A may include three male members and two female members. Similarly, the processor may create a plurality of secondary user groups corresponding to the plurality of categories of the users' preferences.

In 806, the processor (e.g., the group creating module 440) may add the users of the primary user group into the plurality of secondary user groups.

In some embodiments, the processor may determine a user set. The user set may refer to a set that includes at least a part of a plurality of users of that send the confirmation information. More specifically, the processor may add the at least a part of the plurality of users of the primary user group who send the confirmation information to the server 110 into the user set. In some embodiments, the primary user group may include a destination group or a time group.

The processor may add at least a part of the plurality of users of the user set having the same category of the users' preferences into a corresponding secondary user group. Merely for illustration purposes, for five users in the user set, U1, U2, U3, U4, U5, if the users U1 and U2 have the same preferences (e.g., corresponding to a category A), the processor may add the users U1 and U2 into a corresponding secondary user group A. In some embodiments, the users in the same secondary user group may chat in group, or share information (e.g., location information, video information, etc.) with each other.

In some embodiments, as illustrated in operations 802-806, the processor may obtain a plurality of categories of the users' preferences. For each of the plurality of categories of the users' preferences, the processor may select users from the user set that correspond to the category of the users' preferences, and add the users into a secondary user group. In some embodiments, the processor may remove the users that have been added to the secondary user group from the user set.

In some embodiments, if the user preference information only includes gender information, the user preferences may be classified into two categories. One of the two categories is that all the members of the secondary user group are males, and the other one of the two categories is that all the members of the secondary user group are females. For example, the processor may classify a plurality of users that correspond to a category, which requires all the members of the secondary user group are males, into a secondary user group. The plurality of users may include male users of the user set that have same user preferences and/or male users of the user set that did not set user preferences.

If the users' preferences include both gender information and the number of users in a user group, the processor may determine the categories of the users' preferences by combining the gender information and the number of users in a user group. For example, provided that gender information can be categorized into two categories including a first category that the members of a user group are males and a second category that the members of a user group are females. The number of users can be categorized into three categories including a first category that the number of members of a user group is 2-5, a second category that the number of members of a user group is 6-9, a third category that the number of members of a user group is greater than or equal to 10. The processor may determine six categories based on the gender information and the number of users. For each of the six categories, the processor may determine six secondary user groups corresponding to the six categories, respectively. The processor may add the plurality of users of the user set that correspond to the six categories of users' preferences to corresponding secondary user groups.

In some embodiments, a female user of the user set requires to join a certain user group (e.g., a secondary user group) according to the user preference sent by herself. The processor may determine a category that all the members of a secondary user group are males. The processor may add a plurality of male users of the user set that did not express their preferences (i.e., did not send gender information) into the secondary user group. The secondary user group includes both the plurality of male users of the user set that do not send gender information and the female user. In some embodiments, if the processor fails to create a desired secondary user group that satisfy the user preference information, the processor may prompt a failure on creating a user group via the user terminal, and suggest the user to reset his/her preferences.

In some embodiments, the processor may receive exit information from a user for seceding from the one or more user groups, and remove the user out of the one or more user groups in response to the exit information.

After the user sends the exit information to the processor via the user terminal (e.g., the requestor terminal 130), the processor may remove the user out of a corresponding user group, and the user may no longer receive any information (e.g., messages, locations of members in the user group) from the user group. In some embodiments, the user may send the exit information by clicking a button or icon for exiting the user group on the display of the user terminal. In some embodiments, if the user has arrived at the destination, the processor may pop up a dialog box for exiting the user group, the user may choose to exit the user group by the dialog box, and the requestor terminal 130 send the exit information to the processor.

A non-transitory computer readable medium (e.g., the storage device 150 or the memory 220) may be provided for creating one or more user groups. The non-transitory computer readable medium may include at least one set of instructions for creating the user group. When at least one processor (e.g., the processing engine 112 or the processor 210) invoke the at least one set of instructions, the processor may obtain order information from a plurality of users, and classify the plurality of users into one or more user groups based on the order information. The processor may send invitation information for joining a user group to each of the plurality of users of the one or more user groups. When receiving response information associated with the invitation information from at least a part of the plurality of users, the processor may add the at least a part of the plurality of users into user groups based on the response information.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “module,” “unit,” “component,” “device,” or “system.” Furthermore, aspects of the present disclosure may take the form of a computer program product embodied in one or more computer-readable media having computer readable program code embodied thereon. The one or more computer-readable media may include ROM, RAM, magnetic disk, optical disk, or the like, or any combination thereof.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object-oriented programming language such as Java, Scala, Smalltalk, Eiffel, JADE, Emerald, C++, C#, VB. NET, Python or the like, conventional procedural programming languages, such as the “C” programming language, Visual Basic, Fortran 2003, Perl, COBOL 2002, PHP, ABAP, dynamic programming languages such as Python, Ruby, and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations, therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software-only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claim subject matter lie in less than all features of a single foregoing disclosed embodiment.

1. A method for creating a user group, the method implemented on a computing device having at least one processor and at least one computer-readable storage medium, the method comprising:
obtaining, by the at least one processor, order information from a plurality of users;
classifying, by the at least one processor, the plurality of users into one or more user groups based on the order information;
sending, by the at least one processor, invitation information for joining a user group to each of the plurality of users of the one or more user groups;
receiving, by the at least one processor, response information associated with the invitation information from at least a part of the plurality of users; and
adding the at least a part of the plurality of users into the one or more user groups based on the response information.

2. The method of claim 1, wherein classifying, by the at least one processor, the plurality of users into one or more user groups based on the order information includes:
obtaining destinations of the plurality of users; and
classifying the plurality of users into the one or more user groups based on the destinations of the plurality of users.

3. The method of claim 2, wherein classifying the plurality of users into the one or more user groups based on the destinations of the plurality of users includes:
determining a distance between destinations of any two of the plurality of users;
determining the one or more user groups by comparing the distance with a threshold; and
classifying the plurality of users into the one or more user groups based on the comparison.

4. The method of claim 1, wherein classifying, by the at least one processor, the plurality of users into one or more user groups based on the order information includes:
obtaining current locations and corresponding destinations of the plurality of users;
determining a traveling time for each of the plurality of users based on the current locations and corresponding destinations; and
classifying the plurality of users into the one or more user groups based on the traveling time for each of the plurality of users.

5. The method of claim 4, wherein classifying the plurality of users into the one or more user groups based on the traveling time for each of the plurality of users includes:
determining traveling time differences between any two of the plurality of users;
determining absolute values of the traveling time differences;
determining one or more user groups by comparing the absolute values with a threshold; and
classifying the plurality of users into the one or more user groups based on the comparison.

6. The method of claim 1, wherein the response information includes confirmation information and user preferences.

7. The method of claim 6, wherein classifying, by the at least one processor, the plurality of users into one or more user groups based on the order information includes:
classifying, by the at least one processor, the plurality of users into one or more primary user groups based on the order information.

8. The method of claim 7, wherein adding the at least a part of the plurality of users into the one or more user groups based on the response information including:
determining a plurality of categories of the user preferences based on the response information, the primary user group including the at least a part of the plurality of users who send the confirmation information;
creating a plurality of secondary user groups corresponding to the plurality of categories of the user preferences; and
adding the at least a part of the plurality of users of the primary user group into the plurality of secondary user groups.

9-11. (canceled)

12. A system for creating a user group, comprising:
at least one storage medium including a set of instructions; and
at least one processor configured to communicate with the at least one storage medium, wherein when executing the set of instructions, the at least one processor is directed to:
obtain order information from a plurality of users;
classify the plurality of users into one or more user groups based on the order information;
send invitation information for joining a user group to each of the plurality of users of the one or more user groups;
receive response information associated with the invitation information from at least a part of the plurality of users; and
add the at least a part of the plurality of users into the one or more user groups based on the response information.

13. The system of claim 12, wherein to classify the plurality of users into one or more user groups based on the order information, the at least one processor is further directed to:
obtain destinations of the plurality of users; and
classify the plurality of users into the one or more user groups based on the destinations of the plurality of users.

14. The system of claim 13, wherein to classify the plurality of users into the one or more user groups based on the destinations of the plurality of users, the at least one processor is further directed to:
determine a distance between destinations of any two of the plurality of users;
determine the one or more user groups by comparing the distance with a threshold; and
classify the plurality of users into the one or more user groups based on the comparison.

15. The system of claim 12, wherein to classify the plurality of users into one or more user groups based on the order information, the at least one processor is further directed to:
obtain current locations and corresponding destinations of the plurality of users;
determine a traveling time for each of the plurality of users based on the current locations and corresponding destinations; and
classify the plurality of users into the one or more user groups based on the traveling time for each of the plurality of users.

16. The system of claim 15, wherein to classify the plurality of users into the one or more user groups based on the traveling time for each of the plurality of users, the at least one processor is further directed to:
determine traveling time differences between any two of the plurality of users;
determine absolute values of the traveling time differences;
determine one or more user groups by comparing the absolute values with a threshold; and
classify the plurality of users into the one or more user groups based on the comparison.

17. The system of claim 12, wherein the response information includes confirmation information and user preferences.

18. The method of claim 17, wherein to classify the plurality of users into one or more user groups based on the order information, the at least one processor is further directed to:
classify the plurality of users into one or more primary user groups based on the order information.

19. The system of claim 18, wherein to add the at least a part of the plurality of users into the one or more user groups based on the response information, the at least one processor is further directed to:
determine a plurality of categories of the user preferences based on the response information, the primary user group including the at least a part of the plurality of users who send the confirmation information;
create a plurality of secondary user groups corresponding to the plurality of categories of the user preferences; and
add the at least a part of the plurality of users of the primary user group into the plurality of secondary user groups.

20. The system of claim 19, wherein the user preferences include gender information and the number of users in a user group.

21. The system of claim 20, wherein to determine the plurality of categories of the user preferences based on the response information, the at least one processor is further directed to:
determine a first plurality of categories of the gender information based on the response information;
determine a second plurality of categories of the number of users based on the response information; and
determine the plurality of categories of the user preferences based on the first plurality of categories of the gender information and the second plurality of categories of the number of users.

22. The system of claim 12, wherein the at least one processor is further directed to:
receive from a user of the one or more users exit information for seceding from the one or more user groups; and
remove the user out of the one or more groups accordingly.

23. A non-transitory computer readable medium, comprising at least one set of instructions for creating a user group, wherein when executed by at least one processor of a computing device, the at least one set of instructions causes the computing device to perform a method, the method comprising:
obtaining, by the at least one processor, order information from a plurality of users;
classifying, by the at least one processor, the plurality of users into one or more user groups based on the order information;
sending, by the at least one processor, invitation information for joining a user group to each of the plurality of users of the one or more user groups;
receiving, by the at least one processor, response information associated with the invitation information from at least a part of the plurality of users; and
adding the at least a part of the plurality of users into the one or more user groups based on the response information.
